(19) United States
(12) Patent Application Publication
(10) Pub. No.: US 2024/0073537 A1
(43) Pub. Date: Feb. 29, 2024

(54) INFORMATION PROCESSING DEVICE, INFORMATION PROCESSING METHOD, AND PROGRAM

(71) Applicant: SONY INTERACTIVE ENTERTAINMENT INC., Tokyo (JP)

(72) Inventors: DAISUKE TSURU, Chiba (JP); Tatsuo Tsuchie, Tokyo (JP); Hirofumi Okamoto, Tokyo (JP)

(21) Appl. No.: 18/451,829

(22) Filed: Aug. 17, 2023

(30) Foreign Application Priority Data
Aug. 24, 2022 (JP) 2022-133390

(51) Int. Cl. H04N 23/71; A63F 13/655; G06T 7/73; G06V 20/20; H04N 23/72

(52) U.S. Cl. CPC H04N 23/71; A63F 13/655; G06T 7/74; G06V 20/20; H04N 23/72; H04N 13/207

(57) ABSTRACT

There is provided an information processing device including a photographed-image acquisition section that acquires a photographed image taken by a camera mounted on a head-mount display, and a photographing parameter that is adjusted according to a brightness with use of the camera, and a play area control section that detects a play area for defining a movable range of a user by analyzing the photographed image while changing an analysis condition according to an estimated brightness on the basis of the photographing parameter, and then, acquiring 3D information regarding a real object.

### CROSS REFERENCE TO RELATED APPLICATIONS

This application claims the benefit of Japanese Priority Patent Application JP 2022-133390 filed Aug. 24, 2022, the entire contents of which are incorporated herein by reference.

### BACKGROUND

The present technology relates to an information processing device and an information processing method for acquiring state information on a real world by using a photographed image.

Image display systems for allowing a user wearing a head-mount display, to view a subject space from a free view point, have become widespread. For example, electronic content in which a display target is a virtual three-dimensions (3D) display space, and a virtual reality (VR) is realized by displaying, on a head-mount display, an image corresponding to a view line of a user, has been known. A head-mount display can enhance a feeling of immersion into an image, or can improve the operability of an application of a game or the like. In addition, a walk-through system for allowing a user who is wearing a head-mount display and physically moving, to virtually walk around in a displayed image space, has been developed.

### SUMMARY

In order to realize a high-quality user experience by the above-mentioned technology, it is necessary to constantly obtain the accurate state of a real object, such as the position or posture of a user, or a positional relation with a piece of furniture or a wall in the surrounding area. However, when a large amount of information n is required and the accuracy of the information is required, the number of necessary devices including a sensor is increased. Thus, a production cost, a weight, and a power consumption become problems. To solve the problems, a photographed image that can be displayed, may be analyzed to obtain the state of a real object. However, the appearance of the same real object image may have variation according to the photography situation or environment. This causes a problem that the accuracy of acquiring information becomes unstable, or that acquisition of information fails.

The present technology has been made in view of the above-mentioned problems. It is desirable to provide a technology of acquiring information regarding a real world with stable accuracy by using a photographed image.

According to an embodiment of the present technology, there is provided an information processing device. The information processing device includes a photographed-image acquisition section that acquires a photographed image taken by a camera mounted on a head-mount display, and a photographing parameter that is adjusted according to a brightness with use of the camera, and a play area control section that detects a play area for defining a movable range of a user by analyzing the photographed image while changing an analysis condition according to an estimated brightness on the basis of the photographing parameter, and then, acquiring 3D information regarding a real object.

Further, there is provided an information processing method. The information processing method includes acquiring a photographed image taken by a camera mounted on a head-mount display, and a photographing parameter that is adjusted according to a brightness with use of the camera, and detecting a play area for defining a movable range of a user by analyzing the photographed image while changing an analysis condition according to an estimated brightness on the basis of the photographing parameter, and then, acquiring 3D information regarding a real object.

It is to be noted that a system, a computer program, a recording medium having a computer program recorded in a readable manner, or a data structure, which is obtained by translating any combination of the above constituent elements or an expression in the present technology, is also effective as an aspect of the present technology.

According to the present technology, information regarding a real world can be acquired with stable accuracy using a photographed image.

### BRIEF DESCRIPTION OF THE DRAWINGS

FIG. 1 is a diagram depicting an outer experience example of a head-mount display according to the present embodiment;

FIG. 2 depicts a configuration example of an image display system according to the present embodiment;

FIG. 3 is a diagram for explaining an example of an image world that an image generation device displays on a head-mount display in the present embodiment;

FIG. 4 is a diagram for giving a general description of a principle of Visual SLAM;

FIG. 5 is a diagram depicting an internal circuit configuration of an image generation device according to the present embodiment;

FIG. 6 is a diagram depicting an internal circuit configuration of a head-mount display according to the present embodiment;

FIG. 7 is a block diagram depicting functional blocks of the image generation device according to the embodiment;

FIG. 8 is a diagram depicting the detailed configuration of functional blocks of a play area control section according to the present embodiment;

FIG. 9 is a diagram of an image that a play area determination section displays in a play area according to the present embodiment;

FIG. 10 is a diagram for explaining a process in which a point generation section generates point information in the present embodiment;

FIG. 11 is a diagram for explaining a method in which the point generation section determines the validity of a result of block matching in the present embodiment;

FIG. 12 is a diagram depicting an example of point information generated by the point generation section in the present embodiment;

FIGS. 13A and 13B depict diagrams for explaining a method in which the play area determination section detects a floor surface in the present embodiment;

FIG. 14 is a diagram for explaining a method in which the play area determination section generates data on a floor surface corresponding to a play area in the present embodiment; and

FIG. 15 is a diagram depicting a structure example of data that is stored in an analysis condition storage section in the present embodiment.

### DETAILED DESCRIPTION OF THE REFERRED EMBODIMENT

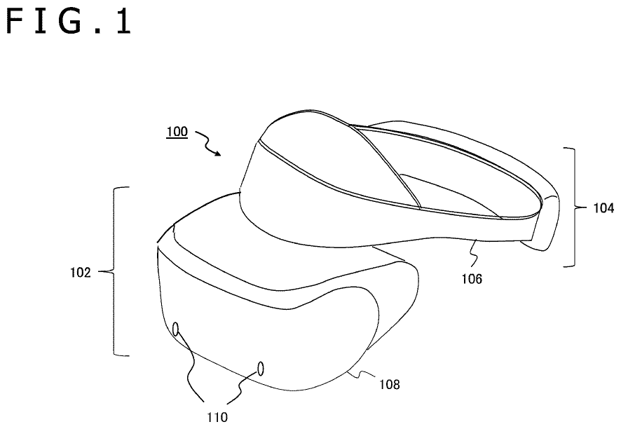

The present embodiment relates to an image display system for displaying an image on a head-mount display mounted on a user's head. FIG. 1 depicts an example of an appearance of a head-mount display 100. In this example, the head-mount display 100 is formed of an output structure part 102 and a fitting structure part 104. The fitting structure part 104 includes a fitting band 106 that surrounds the head of the user when worn by the user such that the device is fixed.

The output structure part 102 includes a casing 108 that is formed to cover left and right eyes when the user is wearing the head-mount display 100. A display panel that directly faces the eyes when the user is wearing the head-mount display 100 is included in the casing 108. Furthermore, the casing 108 may include an ocular lens that is positioned between the display panel and the user's eyes when the user is wearing the head-mount display 100, and that enlarges the viewing angle of the user.

The head-mount display 100 may further include a loudspeaker or an earphone at a position that corresponds to a user's ear when the user is wearing the head-mount display 100. In addition, the head-mount display 100 includes a motion sensor. The motion sensor detects translation movement or rotational movement of the head of the user wearing the head-mount display 100, and further, detects the position and the attitude at each clock time.

The head-mount display 100 further includes a stereo camera 110 on the front surface of the casing 108. The stereo camera 110 takes a video of a surrounding real space within a viewing field corresponding to the visual line of the user. When a photographed image is displayed in real time, an unprocessed real space state in the facing direction of the user can be viewed. That is, video see-through can be realized. Further, augmented reality (AR) can be realized by rendering a virtual object on a real object image in the photographed image.

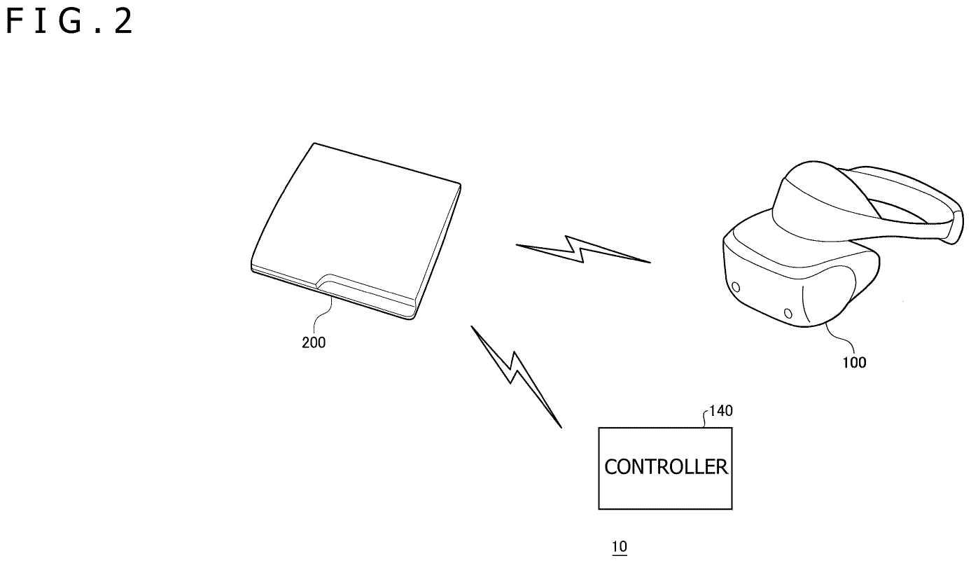

FIG. 2 depicts a configuration example of an image display system according to the present embodiment. An image display system 10 includes the head-mount display 100, an image generation device 200, and a controller 140. The head-mount display 100 is connected to the image generation device 200 by wireless communication. The image generation device 200 may be further connected to a server over a network. In this case, the server may provide data about an on-line application such as a game that a plurality of users can participate in over the network, to the image generation device 200.

The image generation device 200 identifies the visual point position and the visual line direction on the basis of the position/attitude of the head of the user wearing the head-mount display 100, generates a display image in a visual field according to the visual point position and the visual line direction, and outputs the display image to the head-mount display 100. For example, the image generation device 200 may generate a display image of a virtual world where an electronic game is played while proceeding with the game, or may indicate a video to be viewed or to provide information, irrespective of which of a virtual world and a real world is indicated. In addition, in a case where a panoramic image having a wide angle of view centered on the view point of the user is displayed on the head-mount display 100, the user can have a feeling of deep immersion into the displayed image. It is to be noted that the image generation device 200 may be a stationary game machine or may be a personal computer.

The controller 140 (e.g. a game controller) is held by a hand of the user. A user operation for controlling image generation at the image generation device 200, or image display on the head-mount display 100, is inputted to the controller 140. The controller 140 is connected to the image generation device 200 by wireless communication. In one modification, the head-mount display 100 and/or the controller 140 may be connected to the image generation device 200 by wired communication using a signal cable or the like.

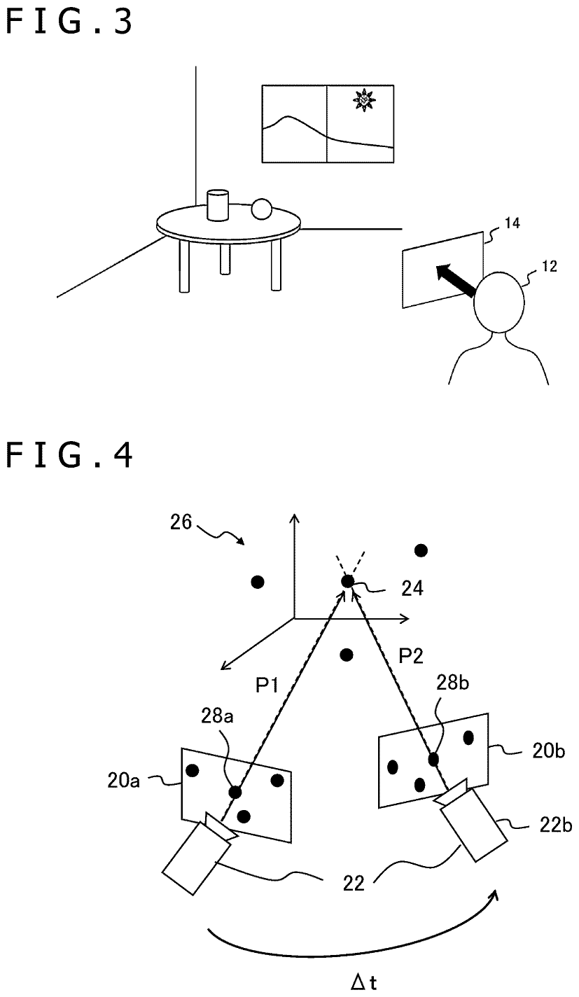

FIG. 3 is a diagram for explaining an example of an image world that the image generation device 200 displays on the head-mount display 100. In this example, a situation where a user 12 is in a room which is a virtual space, is created. The virtual space is defined by a world coordinate system. Objects including a wall, a floor, a window, a table, and items on the table are arranged on the world coordinate system, as illustrated in FIG. 3. The image generation device 200 renders a display image by defining a view screen 14 on the world coordinate system according to the visual point position or visual line direction of the user 12, and then indicating the object image.

The image generation device 200 acquires the state of the head-mount display 100 by a prescribed rate, and changes the position and attitude of the view screen 14 according to the acquired state. Accordingly, image display on the head-mount display 100 can be realized in a visual field that corresponds to the visual point of the user. In addition, the image generation device 200 generates a stereo image having a parallax, and indicates the stereo image in left and right regions of the display panel of the head-mount display 100. Thus, the user 12 can view a virtual space in stereoscopic vision. As a result, the user 12 can experience a virtual reality in which the user feels as if the user is in a room of the displayed world.

In order to realize the image expression in FIG. 3, it is necessary to track the position or attitude of the user head or the head-mount display 100, and control the position and the attitude of the view screen 14 correspondingly with high precision. In a case where the head-mount display 100 is a non-light transmission type, the user 12 may not see the surrounding state in the real space. Therefore, means for avoiding danger to prevent the user from colliding with or stumbling on something, is required. In the present embodiment, necessary information on real objects is acquired with use of a photographed image taken by the stereo camera 110.

It is preferable to take a video see-through image at an angle of view that is wide enough to cover the visual field range of human beings. In this case, most of information regarding a real object in the surrounding area of a user and information regarding the position or attitude of the user head with respect to the real object is included in the photographed image. The present embodiment uses the information to analyze the photographed image. Accordingly, necessary information can be efficiently obtained without providing an additional dedicated sensor. In the following explanation, the position and/or the attitude of the head-mount display 100 is referred to as the “state” of the head-mount display, in some cases.

Visual simultaneous localization and mapping (SLAM) has been known as a technology for simultaneously estimating the position of a mobile body equipped with a camera and creating an environmental map by using a photographed image. FIG. 4 is a diagram for giving a general description of the principle of Visual SLAM. A camera 22 is provided on a mobile body. The camera 22 takes a video of a real space 26 within a visual field range while changing the position and the attitude of the camera 22. It is assumed that feature points 28a and 28b, which indicate the same point 24 of a subject, are extracted from a frame 20a taken at a certain clock time and a frame 20b taken a time Δt later, respectively.

The position coordinate misalignment between the corresponding feature points 28a and 28b (hereinafter, referred to as “corresponding points” in some cases) in respective frame planes depends a position change and an attitude change of the camera 22 during the time Δt. Specifically, the following relational expression is established:

P1=R·P2+T

in which R and T represent matrices that indicate changes based on rotational movement and translation movement of the camera 22, respectively, and P1 and P2 represent 3D vectors from the camera 22 to the point 24 at respective points of time.

The above relation is used to extract the corresponding points in a plurality of frames and solve simultaneous equations. As a result, a position change and an attitude change of the camera 22 during the time Δt is identified. In addition, an error in the derived result is minimized through recursive calculation, so that 3D information (for example, the point 24) regarding a surface of the subject in the real space 26 can be precisely constructed. It is to be noted that, in a case where the stereo camera 110 is used as the camera 22, 3D position coordinates of the point 24 or the like is obtained at each point of time independently. This facilitates the calculation. In the following explanation, the term “point” of the point 24, for example, refers to a point in a real space indicated by a feature point in a photographed image.

In the image display system 10 according to the present embodiment, the 3D structure of a certain real object in the surrounding area of the user is identified on the basis of feature points that are seen in photographed images obtained by the stereo camera 110, and further, the position and the attitude of the head-mount display 100 are tracked. In a case where the 3D structure, the position, and the attitude are obtained from the photographed images, the accuracy of extracting the feature points or the accuracy of information to be finally acquired greatly depend on the photography environment. For example, the amount of light incident on an image sensor is small in a dark place. However, if the stereo camera 110 adjusts the exposure or the gain, an image being displayed in a see-through mode is unlikely to present a visual problem.

Meanwhile, in a case where feature points are extracted to acquire information regarding a real object, a noise component in a photographed image of a dark place can have a great influence on the information. That is, since amplified noise is extracted as feature points, many false points corresponding to the feature points are included in 3D information. In some cases, information indicating that a surface that is not actually present is present may be generated. If the image is corrected in order to reduce the noise, an actual feature point is also lost. Thus, it is difficult to detect a surface. In addition, if an algorithm or a filter for reducing noise is uniformly applied, the degree of the details of a photographed image of a bright place, which has been correctly obtained, is deteriorated. Thus, the accuracy of detecting a surface can be still deteriorated.

Therefore, according to the present embodiment, an automatic correction function of the stereo camera 110 is used to estimate the brightness in the photography environment, and conditions to be introduced to an image analysis are changed on the basis of the brightness. Specifically, the image display system 10 directly or indirectly checks a photographing parameter, which is an exposure time, an analog gain, or a digital gain, for example, adjusted according to the surrounding brightness (intensity), and acquires the real condition of the brightness on the basis of the photographing parameter. Further, an image analysis condition is determined so as to increase the accuracy of information regarding a real object to be focused in a photographed image of the corresponding range.

The purpose of acquiring information through an image analysis is not limited, but an example in which such information is acquired for determining a play area will be mainly explained below. A play area is a real world range where a user wearing the head-mount display 100 can move during an application play. In a case where the user is about to leave the play area or is outside the play area during an application such as a VR game, the image display system 10 depicts the user an alarm for calling an attention or an alarm for prompting the user to return to the play area.

Therefore, the user can enjoy the application safely even when being unable to see the surrounding real space. In order to determine the play area, it is important to detect a floor surface for reference. According to the present embodiment, an image analysis is conducted on the basis of a photographing parameter, so that a floor surface is stably detected irrespective of the brightness, and thus, the play area can be accurately determined. However, the present embodiment is not intended to limit the attention target to a floor, and is applicable to any type of a real object according to the situation.

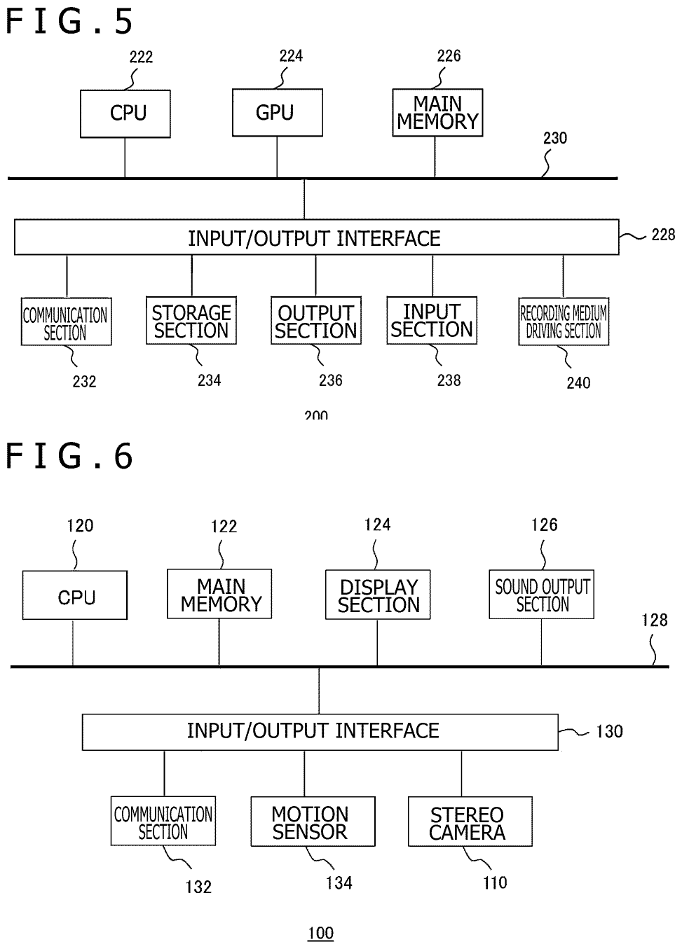

FIG. 5 is a diagram depicting an internal circuit configuration of the image generation device 200. The image generation device 200 includes a central processing unit (CPU) 222, a graphics processing unit (GPU) 224, and a main memory 226. These sections are mutually connected via a bus 230. Further, an input/output interface 228 is connected to the bus 230. The communication section 232, the storage section 234, the output section 236, the input section 238, and the recording medium driving section 240 are connected to the input/output interface 228.

The communication section 232 includes an interface for a universal serial bus (USB) or an Institute of Electrical and Electronics Engineers (IEEE) 1394 peripheral device, and an interface for networks such as a wired local area network (LAN) or a wireless LAN. The storage section 234 includes a hard disk drive or a nonvolatile memory, for example. The output section 236 outputs data to the head-mount display 100. The input section 238 receives a data input from the head-mount display 100, and further, receives a data input from the controller 140. The recording medium driving section 240 drives a removable recording medium which is a magnetic disk, an optical disk, an optical disk, a semiconductor memory, or the like.

The CPU 222 generally controls the image generation device 200 by executing an operating system stored in the storage section 234. In addition, the CPU 222 executes a program (e.g. a VR game application) that is read out from the storage section 234 or a removable storage medium and is loaded into the main memory 226, or a program that is downloaded via the communication section 232. The GPU 224 has a geometry engine function and a rendering processor function. The GPU 224 performs rendering according to a rendering command supplied from the CPU 222, and outputs a result of the rendering to the output section 236. The main memory 226 is formed of a random access memory (RAM), and is configured to store programs and data that are necessary for processes.

FIG. 6 depicts an internal circuit configuration of the head-mount display 100. The head-mount display 100 includes a CPU 120, a main memory 122, a display section 124, and a sound output section 126. These sections are mutually connected via a bus 128. Further, an input/output interface 130 is connected to the bus 128. A communication section 132 equipped with a wireless communication interface, a motion sensor 134, and the stereo camera 110 are connected to the input/output interface 130.

The CPU 120 processes information acquired from the sections of the head-mount display 100 via the bus 128, and supplies a display image and sound data acquired from the image generation device 200, to the display section 124 and the sound output section 126. The main memory 122 stores programs and data that are necessary for processes at the CPU 120.

The display section 124 includes a display panel such as a liquid crystal panel or an organic electroluminescent (EL) panel, and is configured to display an image before the eyes of a user who is wearing the head-mount display 100. The display section 124 may realize a stereoscopic vision by indicating a pair of stereo images in regions corresponding to the left and right eyes. The display section 124 may further include a pair of lenses that are positioned between the display panel and the user's eyes when the user is wearing the head-mount display 100, and that enlarge the viewing angle of the user.

The sound output section 126 is formed of a loudspeaker or an earphone that is provided at a position corresponding to an ear of the user who is wearing the head-mount display 100. The sound output section 126 makes the user hear a sound. The communication section 132 is an interface for exchanging data with the image generation device 200, and performs communication by a known wireless communication technology such as Bluetooth (registered trademark). The motion sensor 134 includes a gyro sensor and an acceleration sensor, and obtains an angular velocity or an acceleration of the head-mount display 100.

As illustrated in FIG. 1, the stereo camera 110 is formed of a pair of video cameras that photograph a surrounding real space from left and right viewpoints, within a visual field that corresponds to the visual point of the user. A frame of a video taken by the stereo camera 110 includes an object that is present in the user visual line direction (typically, the front direction of the user). A measurement value obtained by the motion sensor 134 and data on a photographed image taken by the stereo camera 110 are transmitted to the image generation device 200, if needed, via the communication section 132.

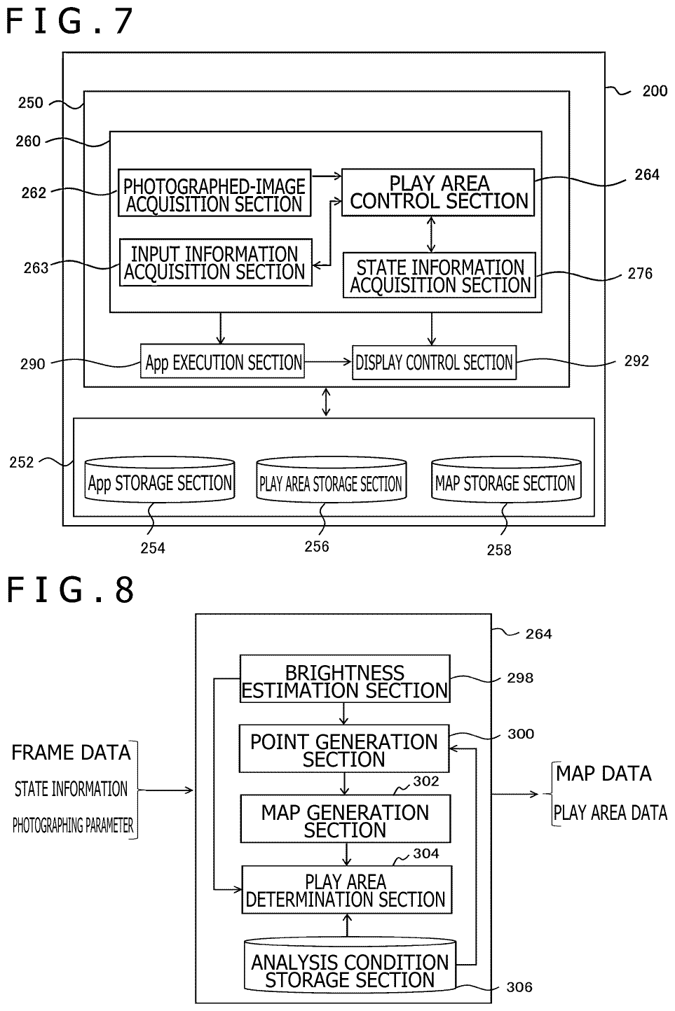

FIG. 7 is a block diagram depicting functional blocks of the image generation device. It is to be noted that at least part of the functions of the image generation device 200 depicted in FIG. 7 may be installed in the head-mount display 100, or may be installed in a server that is connected with the image generation device 200 over a network. In addition, among the functions of the image generation device 200, a function for acquiring information regarding a real object by using a photographed image, may be separately implemented as an information processor.

In addition, the functional blocks depicted in FIG. 7 are implemented by the CPU 222, the GPU 224, the main memory 226, the storage section 234, etc. depicted in FIG. 5, in terms of hardware, and are implemented by computer programs having the functions of the functional blocks in terms of software. Therefore, a person skilled in the art will understand that these functional blocks can be implemented in many different ways by hardware, by software, or a combination thereof, and that the functional blocks are not limited to a particular way.

The image generation device 200 includes a data processing section 250 and a data storage section 252. The data processing section 250 executes various types of data processing. The data processing section 250 exchanges data with the head-mount display 100 and the controller 140 via the communication section 232, the output section 236, and the input section 238 depicted in FIG. 5. The data storage section 252 is implemented by the storage section 234 depicted in FIG. 5, for example, and stores data that is checked or updated by the data processing section 250.

The data storage section 252 includes an App storage section 254, a play area section 256, and a map storage section 258. The App storage section 254 stores a program or object model data that is necessary to execute an application (e.g. a VR game) which involves image display. The play area section 256 stores data about a play area. The data about a play area includes data indicating the positions of points including the boundary of a play area (e.g. coordinate values of the points on the world coordinate system).

The map storage section 258 stores registration information for acquiring the position and the attitude of the head-mount display 100 or the head of a user wearing the head-mount display 100. Specifically, the map storage section 258 stores data on a key frame for Visual SLAM, and data about an environmental map (hereinafter, referred to as “map”) indicating the structure of an object surface in a 3D real space, in association with each other.

The key frame is data on a frame selected, from among frames from which feature points have been extracted by Visual SLAM, on the basis of a prescribed criterion that, for example, the frame has at least a prescribed number of feature points. The key frame is regarded as a “past frame,” and is used to collate the feature points with those in the present frame (latest frame). Accordingly, errors that are accumulated with the elapse of time when the position and the attitude of the head-mount display 100 are tracked, can be canceled.

The map data is information regarding 3D position coordinates of points including an object surface that is present in a real space where the user is. These points are associated with the respective feature points extracted from the key frame. Data about the key frame is associated with the state of the stereo camera 110 when the key frame was acquired. The number of feature points to be included in the key frame may be 24 or greater. The feature points may include a corner detected by a publicly-known corner detection method, or may be detected on the basis of a brightness gradient.

The data processing section 250 includes a system section 260, an App execution section 290, and a display control section 292. The functions of these functional blocks may be installed in a computer program. The CPU 222 and the GPU 224 of the image generation device 200 may exhibit the functions of the above functional blocks by reading out the computer program from the storage section 234 or a recording medium to the main memory 226 and executing the computer program.

The system section 260 executes a system process concerning the head-mount display 100. The system section 260 provides a service that is common to a plurality of applications (e.g. VR games) for the head-mount display 100. The system section 260 includes a photographed-image acquisition section 262, an input information acquisition section 263, a play area control section 264, and a state information acquisition section 276.

The photographed-image acquisition section 262 sequentially acquires photographed image frame data taken by the stereo camera 110. The frame data is transmitted from the head-mount display 100. In association with data on each photographed image frame, the photographed-image acquisition section 262 acquires state information on the head-mount display 100 when the frame was photographed, and a photographing parameter of the frame. The state information is obtained from a measurement value that is obtained by the motion sensor 134 of the head-mount display 100.

The photographing parameter is adjusted by the stereo camera 110 according to the brightness in a photography environment. For example, the photographing parameter is at least any one of an exposure time, an analog gain, and a digital gain, for example. However, the photographing parameter is not limited thereto. The input information acquisition section 263 acquires the content of a user operation via the controller 140.

The play area control section 264 determines a play area by using the photographed image frame data, and then, depicts an alarm, as appropriate, when the user is approaching the boundary during execution of the application. In a case where a play area is determined, the play area control section 264 generates map data by the above-mentioned Visual SLAM, for example. In addition, by using the map data, the play area control section 264 automatically determines, as the play area, the range of a floor surface on which the user does not collide with an obstacle such as a piece of furniture or a wall.

The play area control section 264 may display, on the head-mount display 100, an image indicating the boundary of the determined play area, and then, receive a user operation for editing the play area. In this case, the play area control section 264 acquires the content of the user operation performed on the controller 140 via the input information acquisition section 263, and changes the shape of the play area according to the user operation.

The play area control section 264 finally stores data about the determined play area into the play area section 256. The play area control section 264 stores the generated map data and data about a concurrently obtained key frame into the map storage section 258 in association with each other in such a way that these data are read by the state information acquisition section 276 at any later timing.

On the basis of the data about a photographed image frame and the data stored in the map storage section 258, the state information acquisition section 276 acquires the state of the head-mount display 100, or the position and the attitude of the head-mount display 100 at each clock time by Visual SLAM or the like. It is to be noted that the state information acquisition section 276 may use, as the state information, information obtained by integrating information obtained by the image analysis and a measurement value obtained by the motion sensor 134 of the head-mount display 100.

The state information regarding the head-mount display 100 is used for determining a view screen when the application is executed, for monitoring an approach of the user to the boundary of the play area, or for issuing an alarm about an approach to the play area, for example. Therefore, the state information acquisition section 276 supplies the acquired state information to the play area control section 264, the App execution section 290, and the display control section 292, as appropriate, according to the situation. It is to be noted that the play area control section 264 and the state information acquisition section 276 each have an image analysis section function for obtaining 3D information regarding a real object by analyzing a photographed image obtained by the stereo camera 110.

The App execution section 290 reads out data on an application such as a VR game selected by the user, from the App storage section 254, and executes the application. In this case, the App execution section 290 sequentially acquires the state information regarding the head-mount display 100 from the state information acquisition section 276, and determines a view screen in a position and an attitude that correspond to the state information. A VR image is rendered on the view screen. Accordingly, a virtual world of a display target can be displayed within a field of view corresponding to motion of the user head.

Further, the App execution section 290 may generate an AR image during a certain application selected by the user. In this case, the App execution section 290 superimposes a virtual object on a photographed image frame acquired by the photographed-image acquisition section 262. On the basis of the state information acquired by the state information acquisition section 276, the App execution section 290 determines a rendering position of the virtual object. Accordingly, the virtual object can be properly indicated according to a subject included in a photographed image.

The display control section 292 sequentially transmits frame data of a variety of images (e.g. VR images and AR images) generated by the App execution section 290 to the head-mount display 100. Further, to determine a play area, the display control section 292 transmits an image for providing an instruction to look around to the user, an image for depicting the state of a provisionally determined play area and receiving an edit, an image for warning an approach to the boundary of the play area, etc. to the head-mount display 100, if needed.

For example, when determining a play area, the display control section 292 transmits data on a photographed image frame acquired by the photographed-image acquisition section 262 to the head-mount display 100 according to a request from the play area control section 264, so that the photographed image is displayed on the head-mount display 100. As a result, video see-through in which the situation in the real space in the facing direction of the user can be viewed, is realized. Thus, safety of the user is enhanced. It is to be noted that an opportunity for realizing video see-through is not limited to the above-mentioned case. Video see-through may be realized when the user is outside the play area, before or after the application is executed, or when the user requests video see-through, for example.

FIG. 8 is a diagram depicting the detailed configuration of functional blocks of the play area control section 264. The play area control section 264 sequentially acquires data on photographed image frames from the photographed-image acquisition section 262. The frame data is about a stereo image from left and right viewpoints. Each frame data is associated with the photographing-time state information regarding the head-mount display 100 and the photographing parameter. As previously explained, the play area control section 264 constantly acquires and analyzes the acquired data, and then, outputs map data and play area data.

The play area control section 264 includes a brightness estimation section 298, a point generation section 300, a map generation section 302, a play area determination section 304, and an analysis condition storage section 306. The brightness estimation section 298 estimates the brightness in the surrounding area of the head-mount display 100 on the basis of the photographing parameter. The photographing parameter may be at least any one of an exposure time, an analog gain value, and a digital gain value, for example. In a case where two or more parameters are used, the product of the parameters may be used as the photographing parameter.

The brightness estimation section 298 may apply a low pass filter to the photographing parameter which has been transmitted together with the frame data from the head-mount display 100, and estimate the brightness by using the parameter the slight fluctuation of which has been suppressed. In either case, the brightness estimation section 298 determines which predefined category the brightness in the surrounding area of the head-mount display 100 falls under, on the basis of the range of the photographing parameter. When the value of the above-mentioned photographing parameter is greater, the environment is presumed to be darker. Therefore, large, medium, and small categories are defined, for example, and are associated with a dark place, an intermediate brightness place, and a bright place, respectively.

The brightness estimation section 298 may constantly estimate the brightness by using the photographing parameter which is obtained together with the frame data. Accordingly, the analysis can be adaptively changed irrespective of a brightness change in the surrounding area. The brightness estimation section 298 sequentially reports the estimated brightness to the point generation section 300 and the play area determination section 304.

The point generation section 300 extracts corresponding points in stereo images including photographed image frames, and generates information regarding a point on a surface of a real object on the basis of the parallax. From frames photographed when the user is looking around, corresponding points are sequentially extracted, so that information on many points in a wide range is generated.

When many corresponding points are extracted from one frame, the efficiency of acquiring point information and the accuracy of the point information are enhanced. However, if a false corresponding point is extracted, the accuracy of the point information is necessarily deteriorated. The point generation section 300 changes an extraction condition so as to extract as many as true corresponding points on the basis of the brightness estimated by the brightness estimation section 298.

Specifically, according to the brightness, the point generation section 300 changes the intensity of a filter for determining the validity of a corresponding point extracted by block matching. The intensity of the filter refers to a range or the interval of pixels from which a tendency of the similarity obtained by block matching is checked. A more specific method therefor will be explained later.

The map generation section 302 integrates the position coordinates, on a camera coordinate system, of points obtained from the respective frames, in view of the state of the head-mount display 100 when each frame is photographed. Accordingly, map data concerning a world coordinate system is generated. To integrate the position coordinates, many different methods have been proposed. Any one of them may be adopted.

The map generation section 302 may generate map data using a Truncated Signed Distance Function (TSDF) algorithm, for example. In this algorithm, a 3D space is divided into voxels, and the value of the weighted average of the shortest distances between the positional coordinates of points obtained from different visual points and voxels, is used to identify the positional relation between a real object surface and each voxel, or identify the position of the surface.

The play area determination section 304 detects a play area on the basis of the position information on the object surface depicted in the map data. That is, the play area determination section 304 identifies a gravity direction in the world coordinate system on the basis of the state information regarding the head-mount display 100, and obtains, as a floor surface, a surface orthogonal to the gravity direction. Here, the play area determination section 304 changes a condition for extracting a floor surface candidate orthogonal to the gravity direction, according to the brightness.

Furthermore, with reference to the floor surface, the play area determination section 304 acquires a surface of an obstacle such as a wall or a piece of furniture, and determines, as a play area, a floor surface region inside the acquired surface. In order to define a continuous region of a floor surface formed of points, the play area determination section 304 obtains an outline that contains the points. The play area determination section 304 changes a rule for deriving the outline according to the brightness.

For data on surfaces depicted in the map data or a boundary surface of the play area, the play area determination section 304 may also generate a continuous surface by changing the deriving rule in the same manner. The play area determination section 304 makes the thus-determined surfaces visible with latticed objects, and superimposes the surfaces on a video see-through display image, for example, so that the user can confirm the surfaces. As previously explained, the play area determination section 304 may receive a user operation for correcting the displayed floor surface or play area.

The number of points generated by the point generation section 300, or the brightness in the surrounding area has an influence on the accuracy of the processing in which the play area determination section 304 detects a floor surface and derives a continuous floor surface region within the play area. For example, when the number of points is small, a floor surface is unlikely to be detected, and thus, the range of a play area is likely to become unclear. For this reason, the play area determination section 304 changes the analysis condition according to the brightness estimated by the brightness estimation section 298, as previously explained. Accordingly, the accuracy is maintained irrespective of the number of obtained points.

The analysis condition storage section 306 stores data in which categories of brightness to be estimated by the estimation section 298 and analysis conditions to be selected according to the brightness, that is, the values of parameters for use in the analysis are associated with each other. An analysis parameter refers to a parameter that is used in a process in which the point generation section 300 generates point information, a process in which the play area determination section 304 detects a floor surface, or a process in which the play area determination section 304 generates data on a play area. However, the content of the analysis to be applied and the parameter to be associated are not limited as long as the brightness has an influence on the accuracy.

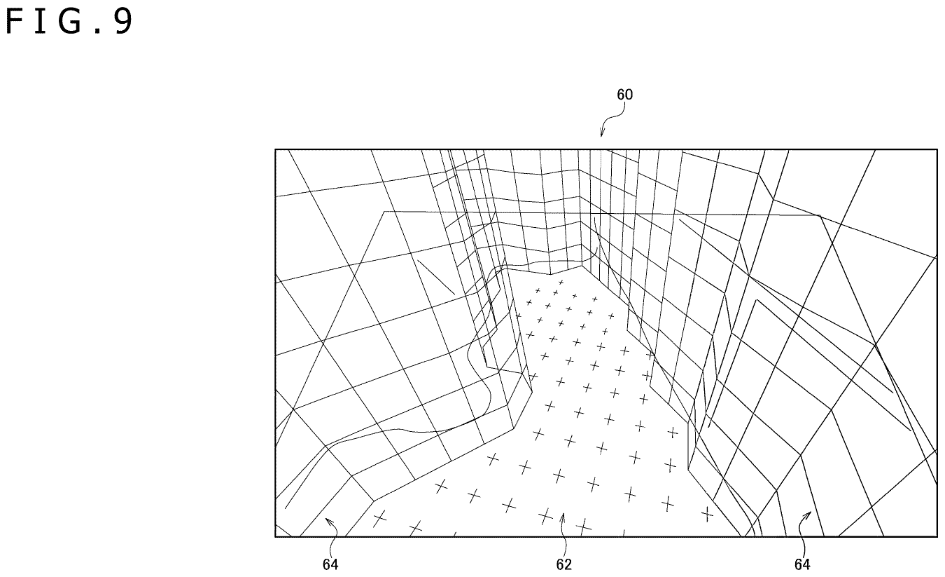

FIG. 9 is a diagram of an image that the play area determination section 304 displays in a play area. A play area image 60 includes a play area part 62 and a boundary surface part 64. The play area part 62 indicates a play area which is a range on a floor surface. For example, the play area part 62 may be an image indicating a translucent latticed object. The boundary surface part 64 indicates the boundary surface of the play area, and indicates a surface that orthogonally intersects, on the boundary of the play area, with the play area play area. The boundary surface part 64 may also indicate a translucent latticed object, for example. As previously explained, the play area determination section 304 may superimpose the depicted images on a video see-through image, and may receive a user operation for correcting the images.

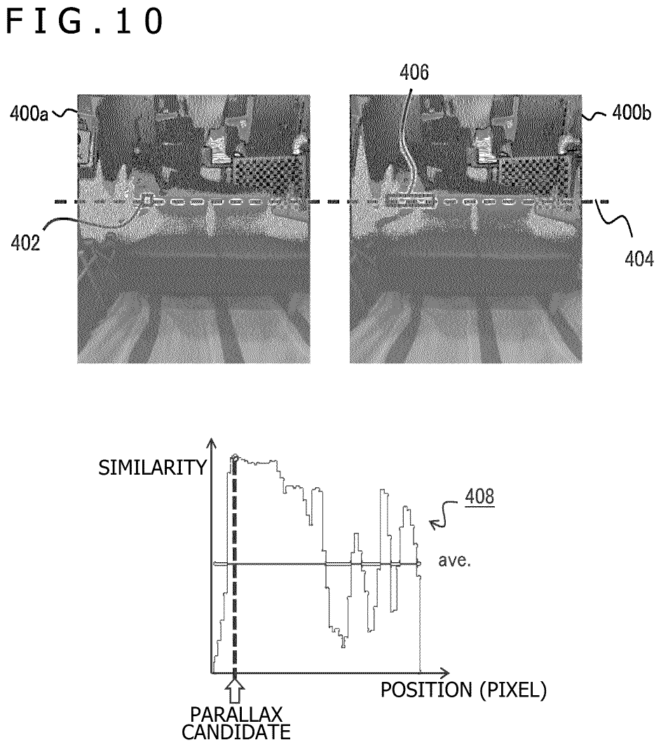

FIG. 10 is a diagram for explaining a process in which the point generation section 300 generates point information. On the basis of a feature point in a stereo image, the point generation section 300 acquires a distance to a point indicated by the feature point. On the basis of the distance to the point and the position coordinates of the feature point in the image plane, the 3D positional coordinates of the point are obtained.

When an object at a distance Z is photographed by the stereo camera 110, an image of the object is depicted in a position, on the plane of the stereo image, deviated horizontally by a parallax D=C/Z. C represents a value that is determined by the camera and the settings of the camera. C can be regarded as a constant during operation. Therefore, the deviation between images of the same object, or between the corresponding points is obtained as the parallax D. As a result, the distance Z is obtained.

In order to obtain the parallax D, the point generation section 300 performs block matching on feature points in a stereo image. More specifically, in a case where a left view point image 400a and a right view point image 400b include a stereo image, the point generation section 300 determines, in the left view point image 400a, for example, a target block 402 having a prescribed size centered on a feature point pixel. Then, in the left view point image 400a, the point generation section 300 determines a search region 406 on an epipolar line 404 corresponding to the target block 402.

It is to be noted that, if the images 400a and 400b are parallelly and stereoscopically converted, the search region 406 can be determined in the horizontal direction at the same height of the target block 402. The point generation section 300 calculates the similarity of a region surrounded by a block frame with the target block 402 while shifting the block frame, which has the same size as the target block 402, by one pixel each sideways in the search region 406. As a result, variation of the similarity based on a pixel particle size is obtained for a position in the search region 406, as depicted in a similarity graph 408 on the lower side.

The similarity is obtained by a well-known calculation method which is Zero-mean Normalized Cross-Correlation (ZNCC), Sum of Squared Difference (SSD), Sum of Absolute Difference (SAD), or Normalized Cross-Correlation (NCC), for example. The point generation section 300 determines, as a pixel corresponding to a feature point in the target block 402, the center pixel of a block frame for which the highest similarity in the similarity graph 408 is obtained, and obtains, as a candidate value of the parallax D, the positional deviation between the pixel and the feature point.

Next, the point generation section 300 determines the validity of the matching result by using pixels surrounding the detected corresponding point. In a case where the highest similarity in the similarity graph 408 indicates a true similarity of an image in the block frame, the similarity is considered to be kept to a certain extent even if the block frame is slightly deviated by a few pixels. For this reason, the average value (for example, an average value ave. in FIG. 10) of the obtained similarities of the peripheral pixels is evaluated to check the possibility that the pixel having the highest similarity is a true corresponding point.

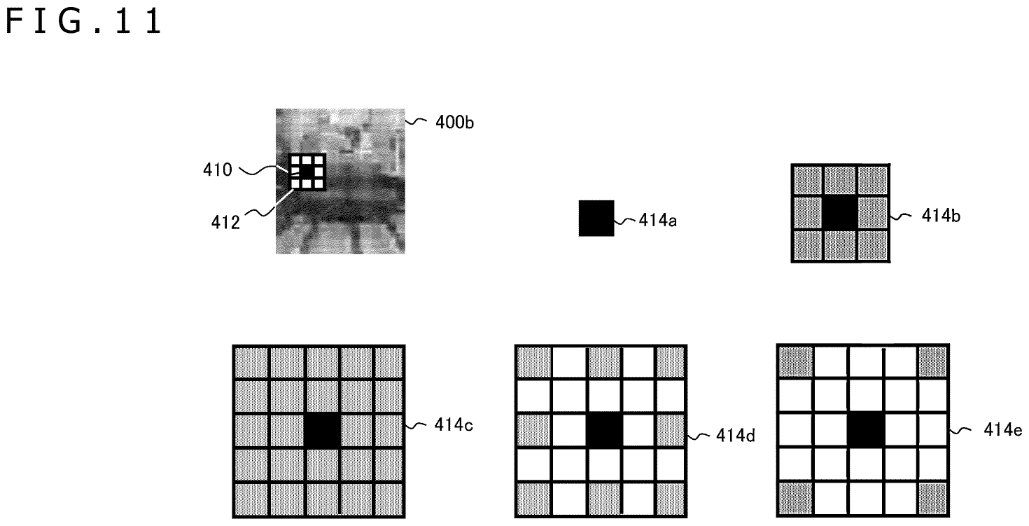

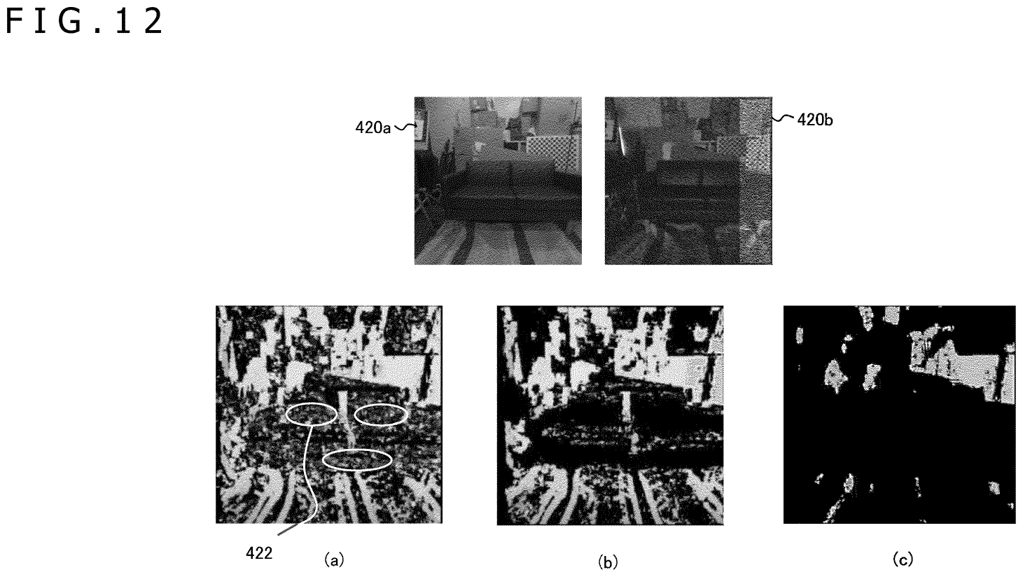

FIG. 11 is a diagram for explaining a method in which the point generation section 300 determines the validity of a result of block matching. The point generation section 300 determines a region 412 having a prescribed range centered on a pixel 410 that is determined as a corresponding point in the right view point image 400b, and calculates the average similarity value of the pixels included in the region 412. When the average similarity value is greater than a prescribed threshold value, the point generation section 300 determines that the result of the block matching performed on the corresponding point which is the pixel 410 is valid, and generates point information based on the parallax D.

According to the photographing parameter, the point generation section 300 changes the range of the region 412 (hereinafter, referred to as kernel) for evaluating the validity and the intervals of pixels the similarity of which is to be sampled. In FIG. 11, a 1×1 pixel kernel 414a, a 3×3 pixel kernel 414b, and 5×5 pixel kernels 414c, 414d, and 414e are depicted as kernel candidates to be changed. In these kernels, each black pixel indicates a pixel determined as a corresponding point, while each shaded pixel indicates a similarity sampling target.

In the kernel 414a, a pixel regarded as a corresponding point itself, is determined as a kernel, the point generation section 300 determines that a matching result is valid if the maximum similarity is greater than a threshold value. In a case where the kernel 414b or the kernel 414c is used, the point generation section 300 determines, as sampling targets, all the peripheral pixels in the kernel, and compares the average similarity value with the threshold value. In a case where the kernel 414d or the kernel 414e is used, the point generation section 300 samples the similarity of every two pixels (every one pixel), or the similarity of every four pixels (every three pixels), and compares the average similarity value with the threshold value.

When a photographed image includes many noise components, an image in a wide range is checked at low resolution. As a result, the accuracy of evaluating the validity can be enhanced qualitatively. For this reason, in a case where a brightness estimated according to the photographing parameter is classified as a dark place, the point generation section 300 adopts the sampling interval and the size of the kernel 414d or the kernel 414e, for example. In a case where the estimated brightness is classified as a bright place, the point generation section 300 adopts the kernel 414a, for example. In a case where the estimated brightness is classified as an intermediate brightness, the point generation section 300 adopts the kernel 414b or the kernel 414c, for example. However, the kernel sizes and the sampling intervals depicted in FIG. 11 are just examples. These kernel sizes and sampling intervals are not intended to impose limitations on the present embodiment.

FIG. 12 is a diagram depicting an example of point information generated by the point generation section 300. Images 420a and 420b on the upper side indicate frames obtained by photographing the same space under a bright environment and a dark environment, respectively. In actuality, respective stereo images are obtained under the bright environment and the dark environment. Distance images in each of which a distance to a point acquired from the image 420b which has been obtained under the dark environment is expressed as a pixel value in an image flat plane, are depicted on the lower side. In (a), a distance image where a kernel has a 1×1 pixel size and a threshold value to be given to an average similarity value is 0, is depicted.

That is, (a) indicates a result obtained by the point generation section 300 determining, as corresponding points, all pixels having the highest similarity as a result of block matching, and generating point information. In this case, the density of the obtained points is high but many false points which are formed due to noise are included in regions (e.g. region 422) surrounded by white lines, for example, if the photographed space is the dark place. If this distance image is reflected on the map, a surface that is actually not present may be included in generated data.

In (b), a distance image where a kernel has a 5×5 pixel size, a sampling interval is 4 pixels, and a threshold value to be given to an average similarity value is 0.2, is depicted. That is, the kernel is enlarged, and the sampling interval is widened. In this case, a spatial correlation is briefly confirmed and a corresponding point having low correlation is eliminated. As a result, a point distribution the configuration of which is close to that of a surface of an object in the original image 420b, is obtained.

In (c), a distance image where a kernel has a 5×5 pixel size, the sampling interval is 4 pixels, and a threshold value to be given to an average similarity value is 0.73, is depicted, similar to (b). That is, compared to (b), the condition for determining a validity is stricter. Thus, even a true point is eliminated. As a result, the amount of information contributing to the map is insufficient, whereby a time may be required to detect a play area, or detection of a play area fails.

Thus, the number of obtained points and the proportion of false points included in the obtained points have great variations according to a kernel size and a sampling interval. In addition, an appropriate value of a threshold value to be given to an average similarity value also has a great variation according to a kernel size and a sampling interval. Therefore, a set of a kernel size, a sampling interval, and a threshold value with which many points are obtained while the number of false points is low, is previously obtained for each bright category by experiment. In FIG. 12, when the condition of (b) is adopted for a dark place, sufficient surfaces are detected with less errors.

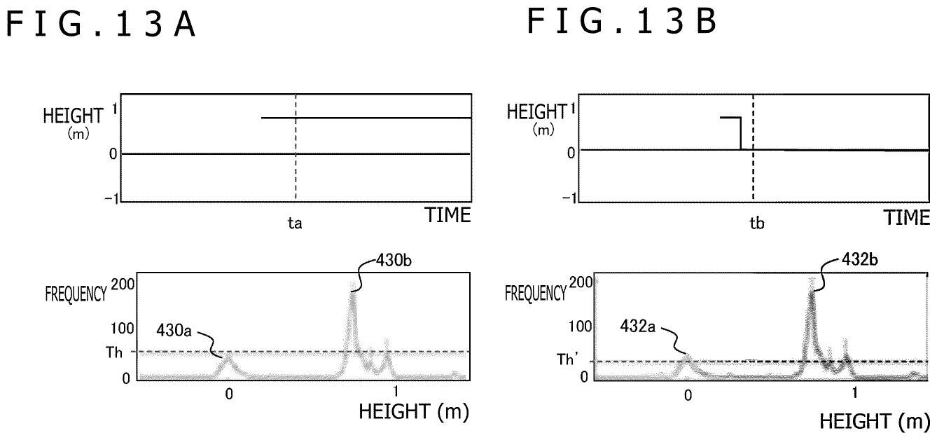

FIGS. 13A and 13B depict diagrams for explaining a method in which the play area determination section 304 detects a floor surface. The play area determination section 304 detects, as a floor surface, a flat surface that satisfies a condition of being orthogonal to the gravity direction and having an area equal to or greater than a prescribed value, from a map generated by the map generation section 302. However, in some cases, a plurality of flat surfaces that satisfy the condition are detected due to a neighboring low table, a neighboring bed, or a step formed on the floor.

In view of these cases, the play area determination section 304 first extracts a plurality of floor surface candidates, and then, selects, as a floor surface, a flat surface that has a large area and is close to the view point of the stereo camera 110. In FIG. 13, floor surface candidates are present at height of 0 m and height of 0.7 m. The candidate at height of 0 m is determined as a floor surface. The upper side in FIG. 13 depicts the height of a floor surface estimated at each clock time by the play area determination section 304 while the horizontal axis indicates the elapse of time. The lower side is a histogram of surface heights, which the play area determination section 304 generates in order to extract floor surface candidates. A frequency in the histogram represents the number of points located on a gravity direction axis in a 3D space of the map.

With proceeding of generation of point information with the elapse of time, the histogram is grown. Histograms obtained at clock times ta and tb, which are indicated by respective broken lines with respect to the elapse of time on the upper side, are depicted on the lower side in FIG. 13. If there is a horizontal surface, many points are depicted in the position of the horizontal surface. Therefore, the maximum point of the histogram indicates the height of the horizontal surface which is present in the space. To extract floor surface candidates, the play area determination section 304 determines a threshold value for a frequency in the histogram and acquires a maximum point that is greater than the threshold value.

Here, a result of extraction of floor surface candidates is influenced by the determined threshold value. That is, in (a), a threshold value Th is greater than an appropriate value. Thus, only a maximum point 430b which corresponds to the height of 0.7 m is extracted. Until the maximum point 430a which corresponds to the height of 0 m exceeds the threshold value Th, a floor surface height is 0.7 m alone irrespective of the elapse of time. As a result, a play area is determined with respect to the height of 0.7 m.

As depicted in (b), in a case where a threshold value Th′ is appropriate, both the maximum points 432a and 432b are obtained, and floor surface candidates at the height of 0 m and 0.7 m are extracted. The play area determination section 304 narrows down the floor surfaces as previously explained, by obtaining the positions and the areas of surfaces at these heights in the map, and comparing with each other. In this example, the height of the floor surface at a certain time clock is estimated to be 0 m, and the play area is determined with respect to the height of 0 m, as depicted on the upper side.

A frequency in a histogram depends on the number of points generated from a photographed image. In a case where an image photographed in a dark place is used, the number of points is generally likely to become small on a condition for eliminating false points. For this reason, a threshold value to be given to a frequency is made small for a dark environment, as depicted in FIG. 13. Accordingly, floor candidates can be fully extracted.

On the other hand, in a case where the threshold value is extremely small, there is a possibility that an accidental maximum point which is caused by noise is extracted as a floor surface candidate. For this reason, a threshold value that can completely extract all true horizontal surfaces only is previously obtained for each brightness category by experiment. Accordingly, the play area determination section 304 switches the threshold value according to an actual brightness category. It is to be noted that the threshold value may be determined so as to depend on a parameter that is determined according to a brightness by the point generation section 300.

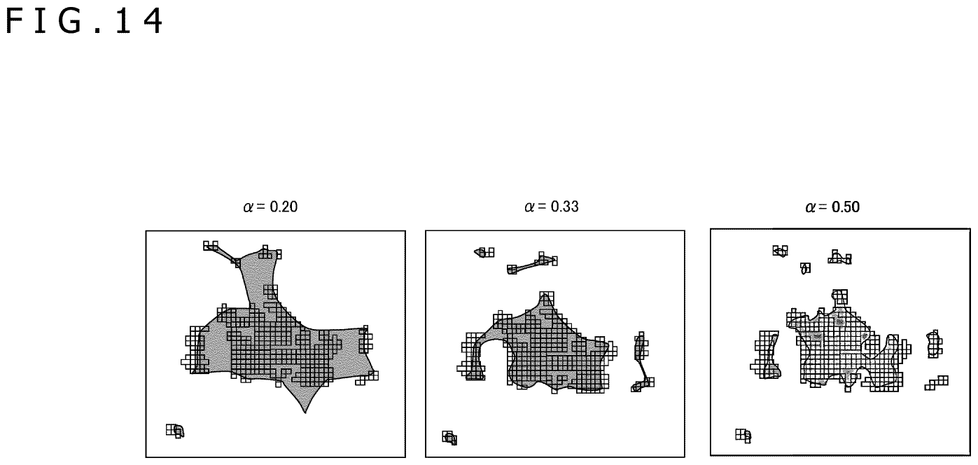

FIG. 14 is a diagram for explaining a method in which the play area determination section 304 generates data on a floor surface corresponding to a play area. The play area determination section 304 precisely determines the range of a play area on a floor surface and makes the range visible with a latticed object. Accordingly, the user can confirm or adjust the play area. Points on the floor surface obtained from corresponding points in a stereo image are discrete. It is necessary to determine a continuous region as a play area on the basis of points included in a region where a collision with an obstacle does not occur.

For this reason, the play area determination section 304 determines the region of a play area by using an alpha shape method, for example. In the alpha shape method, a circle having a radius of 1/α is prepared, and, if the circumference of the circle includes two points of a set of points but the remaining points are not included inside the circle, a line connecting the two points is determined as an edge of the set of points (for example, see H. Edelsbrunner, et. al, “On the shape of a set of points in the plane,” IEEE Transactions on Information Theory, July, 1983, 29(4) p. 551-559).

In FIG. 14, regions (gray regions) that are generated by performing an alpha shape method on a distribution of points on a floor surface represented by small rectangles, with α=0.20, α=0.33, and α=0.50, are compared with one another. When the a value is smaller, the size of a circle for determining an outline becomes larger, and the granularity of the processing becomes smaller. As a result, a region with fewer holes is likely to be generated. In the example in FIG. 14, compared to a case where α=0.20, the region generated when α=0.33 is smaller, and the region generated when α=0.50 is further smaller. In a region generated when the value of a is great, holes are likely to occur and the region is likely to be separated.

Meanwhile, since the number of the original points is small, generated regions are excessively narrow or holes and separations easily occur. In a case where an image photographed in a dark place is used, the number of points is generally likely to become small on a condition for eliminating false points. For this reason, the play area determination section 304 suppresses occurrence of holes and separations by setting the value of a to be small, so that a proper continuous region is generated.

On the other hand, the play area determination section 304 prevents the region from becoming excessively wide, by increasing the value of a in a bright environment. An appropriate value of a for each brightness category is also previously obtained by experiment. The play area determination section 304 switches the value of a according to an actual brightness category. It is to be noted that the appropriate value may depend on a parameter that the point generation section 300 determines according to a brightness, and/or a threshold value that is given to a frequency in a histogram by the play area determination section 304.

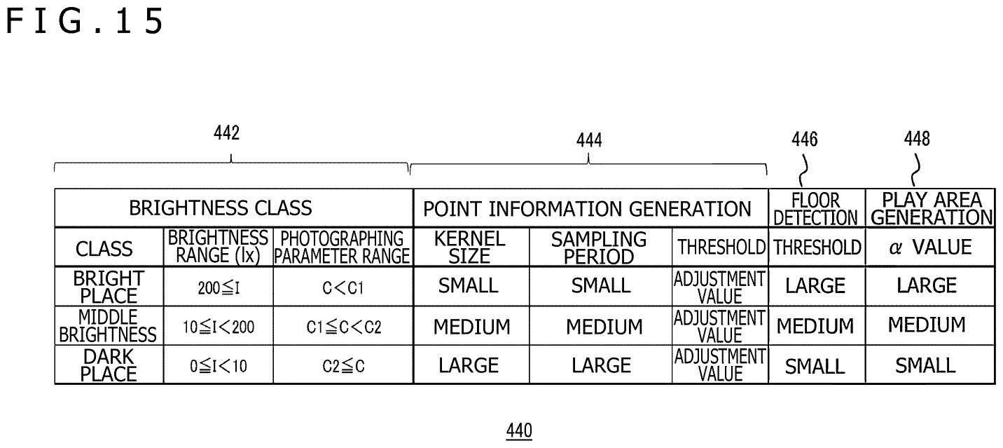

FIG. 15 depicts a structure example of data that is stored in the analysis condition storage section 306. In an analysis condition table 440, a definition 442 concerning a brightness category is associated with analysis conditions 444, 446, and 448 in terms of each category. In the example in FIG. 15, a place having a brightness I of 2001× (lux) or higher, a place having a brightness I of less than 101×, and a place having a brightness of 101 to 2001× are defined as a bright place, a dark place, and an intermediate brightness place, respectively, according to the definition 442 concerning a brightness category. The brightness range is actually estimated with reference to a photographing parameter C.

In a case where any one of an exposure time, an analog gain, and a digital gain, or the product thereof is adopted as the photographing parameter C, the value of C becomes larger for a darker environment. Therefore, in FIG. 15, two threshold values C1 and C2 (C1<C2) are introduced. It is assumed that C<C1 indicates a bright place, C1≤C<C2 indicates an intermediate brightness, and C2≤C indicates a dark place. In actuality, as the threshold values C1 and C2, photographing parameters on the boundaries between the brightness categories are previously obtained by experiment. It is to be noted that the definition 442 concerning a brightness category may be held in the brightness estimation section 298.

As the analysis condition 444 under which the point generation section 300 generates point information, threshold values to be given to a kernel size, a sampling interval, and an average similarity are stored. As previously explained, large, medium, and small values of a kernel size and a sampling interval are determined to indicate a bright place, an intermediate brightness place, and a dark place, respectively. In actuality, optimum values for the respective brightness categories are previously obtained by experiment. Regarding a threshold value to be given to a similarity average, a value for providing high precision is previously obtained as an adjustment value according to a determined kernel size and a determined sampling interval.

As the analysis condition 446 under which the play area determination section 304 detects a floor surface, threshold values for acquiring the maximum point of a histogram are stored. As such threshold values, large, medium, and small values are determined for a bright place, an intermediate bright place, and a dark place, respectively. In actuality, optimum values for the respective brightness categories are previously obtained by experiment. As the analysis condition 448 under which the play area determination section 304 generates data on the region of a play area, values of a for an alpha shape method are stored. As such values, large, medium, and small values are determined for a bright place, an intermediate brightness place, and a dark place, respectively. In actuality, optimum values for the respective brightness categories are previously obtained by experiment.

However, the analysis condition table 440 in FIG. 15 is one example. The brightness categories and the parameters to be controlled are not limited. For example, the brightnesses may be classified into two categories, or may be classified into four or more categories. Moreover, the numerical value of a boundary brightness is not limited. Alternatively, no brightness category may be determined in such a way that parameters are continuously changed according to the value of a photographing parameter. In addition, algorithms for generating point information, detecting a floor, and generating a play area region, are not limited to the above-mentioned ones. A parameter to be controlled may be selected according to an algorithm, as appropriate.

According to the present embodiment explained so far, an image photographed by a stereo camera mounted on a head-mount display is displayed for the purpose of realizing video see-through, AR, or the like, and is further used for an image analysis. In this case, a photographing parameter which is obtained together with frame data, is used to estimate the brightness in the surrounding area, and the value of a parameter to be used for an analysis is switched according to the brightness. For example, during a process for generating points on a surface of a real object from corresponding points in a stereo image obtained in a dark place, a parameter with which a true point is less likely to be lost while a false point caused by noise is eliminated, is selected.

On the basis of a threshold value for the number of points to be regarded as floor surface candidates, or a distribution of the points, a parameter for determining the region of a play area is properly adjusted. Accordingly, even when the number of points obtained from a photographed image has variation due to the influence of the brightness, the accuracy of the final information can be made stable. Thus, the analysis efficiency is enhanced. The robustness of an analysis of a photographed image is enhanced in this manner. Consequently, with a simple structure that does not include an additional sensor, a safe and high quality user experience can be provided.

With the above-mentioned structure, it is unnecessary to provide a dedicated sensor for acquiring various types of information. Accordingly, a high quality image can be expressed with a head-mount display having a simple structure. Furthermore, deterioration of a feeling of wearing the head-mount display, which is caused by an increase of the weight or power consumption, can be avoided.

The present technology has been explained on the basis of the embodiment. The embodiment exemplifies the present technology but a person skilled in the art will understand that various modifications can be made to a combination of the constituent elements or the process steps of the embodiment and that these modifications are also within the scope of the present technology.

What is claimed is:

1. An information processing device comprising:
a photographed-image acquisition section that acquires a photographed image taken by a camera mounted on a head-mount display, and a photographing parameter that is adjusted according to a brightness with use of the camera; and
a play area control section that detects a play area for defining a movable range of a user by analyzing the photographed image while changing an analysis condition according to an estimated brightness on a basis of the photographing parameter, and then, acquiring three-dimensions information regarding a real object.

2. The information processing device according to claim 1, wherein
the play area control section extracts a corresponding point by performing block matching on a stereo image including the photographed image, and changes an intensity of a filter for determining validity of the corresponding point, according to the photographing parameter.

3. The information processing device according to claim 2, wherein,
to change the intensity of the filter, the play area control section changes a range and an interval between pixels from which a tendency of a similarity obtained as a result of the block matching is checked.

4. The information processing device according to claim 1, wherein
the play area control section changes a condition for detecting a floor surface candidate according to the photographing parameter on a basis of a distribution of points in a three-dimensions space, corresponding to feature points in the photographed image.

5. The information processing device according to claim 4, wherein
the play area control section changes, as the detection condition, a threshold value to be given to a histogram of the numbers of points in a gravity direction, according to the photographing parameter.

6. The information processing device according to claim 1, wherein
the play area control section changes a rule for deriving an outline of the play area according to the photographing parameter on a basis of a distribution of points on a floor surface in a three-dimensions space, corresponding to feature points in the photographed image.

7. The information processing device according to claim 6, wherein
the play area control section changes, as the rule for deriving the outline of the play area, an α value in an alpha shape method according to the photographing parameter.

8. The information processing device according to claim 1, wherein
the photographed-image acquisition section acquires, as the photographing parameter, at least any one of an exposure time, an analog gain, and a digital gain.

9. An information processing method comprising:
acquiring a photographed image taken by a camera mounted on a head-mount display, and a photographing parameter that is adjusted according to a brightness with use of the camera; and
detecting a play area for defining a movable range of a user by analyzing the photographed image while changing an analysis condition according to an estimated brightness on a basis of the photographing parameter, and then, acquiring three-dimensions information regarding a real object.

10. A program for a computer, comprising:
by a photographed-image acquisition section, acquiring a photographed image taken by a camera mounted on a head-mount display, and a photographing parameter that is adjusted according to a brightness with use of the camera; and
by a play area control section, detecting a play area for defining a movable range of a user by analyzing the photographed image while changing an analysis condition according to an estimated brightness on a basis of the photographing parameter, and then, acquiring three-dimensions information regarding a real object.
